(19) United States
(12) Patent Application Publication
(10) Pub. No.: US 2018/0029502 A1
(43) Pub. Date: Feb. 1, 2018

(54) SEAT CONTROL APPARATUS

(71) Applicant: Jaguar Land Rover Limited, Coventry, Warwickshire (GB)

(72) Inventors: German GEORGIEV, Coventry, Warwickshire (GB); Rory MANNING, Coventry, Warwickshire (GB)

(21) Appl. No.: 15/551,004

(22) PCT Filed: Feb. 19, 2016
(86) PCT No.: PCT/EP2016/053543

§ 371 Date: Aug. 14, 2017

(30) Foreign Application Priority Data
Feb. 23, 2015 (GB) 1502976.2

(51) Int. Cl. B60N 2/02; G06F 3/0362; G06F 3/0338; B60K 37/06

(52) U.S. Cl. CPC B60N 2/0228; B60K 37/06; G06F 3/0362; G06F 3/0338; E05Y 2400/86; H01H 25/06

(57) ABSTRACT

The present application relates to a seat control apparatus (1) for configuring a vehicle power seat (2). The seat control apparatus (1) has an operating member (12) for cycling through a plurality of control modes (R1-6). The control modes (R1-6) are each associated with at least one configurable seat parameter. The operating member (12) is operable to select one of the control modes (R1-6) and to adjust the at least one configurable seat parameter associated with the selected control mode (R1-6). The present application also relates to a seat control apparatus (1) coupled to a vehicle power seat (2); and to a vehicle (V) incorporating one or more said seat control apparatus (1).

### TECHNICAL FIELD

The present disclosure relates to a seat control apparatus and particularly, but not exclusively, to an apparatus for controlling a vehicle power seat and to a vehicle seat coupled to a seat control apparatus. The present disclosure also relates to a vehicle incorporating one or more seat control apparatus.

### BACKGROUND

It is known to provide a vehicle with a power seat (also referred to as an electric seat) incorporating a series of electric motors to configure the seat. A switch pack comprising a plurality of mechanical switches is typically provided to control the electric motors. With increasing configuration operations being incorporated into a vehicle power seat, increasingly complex switch packs are required to control the electric motors. Due to the high number of possible control operations, users may find seat adjustment complex and confusing. This may be compounded if the switches are not visible in normal use, for example if the switch pack is mounted to a base of the vehicle seat. While controlling seat position and backrest recline angle is relatively intuitive, adjusting features like lumbar support, cushion extension and bolster support can prove more difficult. Users may need to attempt several switches before locating the one which they actually require. Another issue with the currently adopted seat mounted switch pack is the door to seat clearance which can make accessing the switches difficult, especially when the user is wearing a wrist watch or jewelry.

Rather than provide a switch pack for controlling the electric motors, it is known to incorporate the seat controls into a graphical user interface (GUI) displayed on an electronic screen which can, for example, be incorporated into an instrument cluster or a centre console. The GUI can be controlled by mechanical switches associated with the screen or using a touch screen interface. However, developing a GUI which provides intuitive control of the vehicle power seat may presents certain challenges. Moreover, access to the display screen may be limited for passengers in the vehicle, for example they do not have access to a screen or the screen is already in use by the driver.

It is against this background that the present invention has been conceived.

### SUMMARY OF THE INVENTION

Aspects and embodiments of the invention provide a seat control apparatus, a vehicle seat, and a vehicle as claimed in the appended claims.

According to a further aspect of the present invention there is provided a seat control apparatus for configuring a vehicle power seat. The seat control apparatus may comprise an operating member for cycling through a plurality of control modes. Each control mode may be associated with at least one configurable seat parameter.

The operating member may be operable to select one of said control modes and to adjust the at least one configurable seat parameter associated with the selected control mode. The operating member may be utilised to cycle through the control modes and also to adjust the selected control mode. At least in certain embodiments, this arrangement can provide an intuitive user interface for configuring the vehicle power seat. By utilising the operating member also to select the control mode, at least in certain embodiments the user can operate at least the primary functions of the seat control apparatus using only the operating member.

The control modes can be accessible in a predetermined sequence. In use, the operating member cycles through the control modes in the predetermined sequence. The operating member can be operable to select the next control mode in the predetermined sequence. The operating member can be rotatable and/or pivotable and/or translatable. The operating member could be rotated to cycle through the plurality of control modes in said predetermined sequence. The operating member could be pivoted to cycle through the plurality of control modes in said predetermined sequence. The operating member could be translated to cycle through the plurality of control modes in said predetermined sequence. Alternatively, or in addition, the operating member can be depressed to cycle through the plurality of control modes. The control modes can be cycled such that the next control mode in the predetermined sequence is cycled each time the operating member is depressed. The next control mode in the sequence can be selected automatically each time the operating member is depressed.

The operating member can be associated with at least one switch configured to detect operation of the operating member. Alternatively, or in addition, the operating member can be associated with at least one transducer for detecting operation of the operating member. The transducer can be configured to detect movement of the operating member, for example to detect rotational and/or pivoting and/or translational movement of the operating member. The operating member could, for example, comprise a joystick, a rotary dial, a rotary wheel, a trackball or a thumb control. Alternatively, the operating member can comprise a control knob. In use, the user can engage the control knob, for example by gripping the operating member between their index finger and thumb. The control knob could be a 7-directional control knob.

The operating member can be rotatable to adjust the at least one configurable seat parameter associated with the selected control mode. Alternatively, or in addition, the operating member can be pivotable and/or translatable to adjust the at least one configurable seat parameter associated with the selected control mode.

In addition to using the operating member to select the control mode, the seat control apparatus can comprise a selection means. The selection means could be separate from the operating member. For example, the selection means could be in the form of a selector switch or button. The selector switch or button could, for example, be disposed adjacent to the operating member. The selection means could comprise a touch sensor, such as a capacitive sensor.

The seat control apparatus can comprise a first electronic display for providing a visual indication of which one of said control modes is currently selected. The first electronic display can comprise a first electronic display disposed adjacent to or proximal to said operating member.

The seat control apparatus can comprise a second electronic display for providing a visual indication of one or more control function available for adjusting the at least one configurable seat parameter associated with the selected control mode. At least one first control function can be available in a first control mode, and at least one second control function can be available in a second control mode; the at least one first control function being different from said at least one second control function.

The second electronic display can be disposed on said operating member. Alternatively, or in addition, the second electronic display can be disposed proximal to the operating member, for example disposed adjacent to said operating member. The second electronic display can be disposed on an outer surface of the operating member. The second electronic display can comprise one or more light emitting element. The one or more light emitting element can be illuminated to represent the available control function.

The first electronic display and/or the second electronic display can be configured to provide a “secret-till-lit” function so that they are at least partially hidden when not in use. Only certain control function(s) may be available in certain operating modes. The first electronic display and/or the second electronic display can be configured such that only the one or more control function available in a currently selected operating mode is displayed. The one or more control function can correspond to configurable seat parameters in a selected operating mode. The first electronic display and/or the second electronic display can thereby adjust the visible display functions depending on a context provided by a multi-modal system.

The configurable seat parameters can comprise one or more of the following set: seat cushion extension; lumbar support (for example inflation/deflation of a bladder); lumbar position (for example mechanical adjustment of a lumbar support member); bolster support (for example inflation/deflation of a bladder); bolster position (for example mechanical adjustment of a bolster support member); headrest angle; squab angle; upper squab articulation; headrest height; seat height rise; cushion incline; calf support position; foot support position; temperature control; and ventilation control. The seat control apparatus could be used to select and activate a massage function control. The lumbar support is disposed in the middle of the backrest and can, for example, have 4-way adjustment (up, down, out/increase, in/decrease). The bolster support is disposed at the sides of the backrest and can, for example, have 2-way adjustment (increase/decrease).

The seat control apparatus can be re-configured in dependence on the available configurable seat parameters. The seat control apparatus can be configured to allow one or more control mode to be selectively activated/deactivated. The seat control apparatus can thereby be reconfigured, for example for use with vehicle power seats having different configurable features. The seat control apparatus could be reconfigured manually, for example by operating switch means. Alternatively, the seat control apparatus can be reconfigured electronically, for example by means of a configuration signal. The configuration signal could be transmitted by an electronic control unit disposed in the vehicle. Alternatively, the configuration signal could be transmitted from an external controller. The seat control apparatus could, for example, be reconfigured during vehicle assembly or servicing.

The seat control apparatus can be in the form of an integrated switch pack. The seat control apparatus can be suitable for installation in a centre console, an armrest, a vehicle door or a seat base. The armrest could be a door armrest or a central armrest, for example disposed between adjacent seats in the rear of the vehicle. The seat control apparatus can comprise a unitary housing to facilitate installation. The seat control apparatus can comprise an electronic connector for connection to one or more actuator in the vehicle seat. The actuator can, for example, be in the form of a drive motor, a compressor or a pump. The compressor or pump can, for example, be connected to a pneumatic bolster or lumbar support. The seat control apparatus can also be configured for connection to a vehicle communication network, for example to output status information.

The control member can be movable between a non-operative position and an operative position. For example, the control member can be at least partially retracted into the seat control apparatus when in said non-operative position. The control member can be displaced to said non-operative position when the seat control apparatus is de-activated, for example when the vehicle ignition is switched off. The control member can be displaced to said operative position when the seat control apparatus is activated, for example when the vehicle ignition is switched on.

According to a further aspect of the present invention there is provided a vehicle seat coupled to a seat control apparatus as described herein.

According to a still further aspect of the present invention there is provided a vehicle comprising one or more seat control apparatus as described herein. Each seat control apparatus can be associated with one or more vehicle seat disposed in the vehicle.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the present invention will now be described, by way of example only, with reference to the accompanying Figures, in which:

FIG. 1A shows a seat control apparatus in accordance with an embodiment of the present invention;

FIG. 1B shows a schematic representation of the seat control apparatus shown in FIG. 1;

FIG. 10 shows a schematic representation of a vehicle incorporating a plurality of the seat control apparatus shown in FIG. 1;

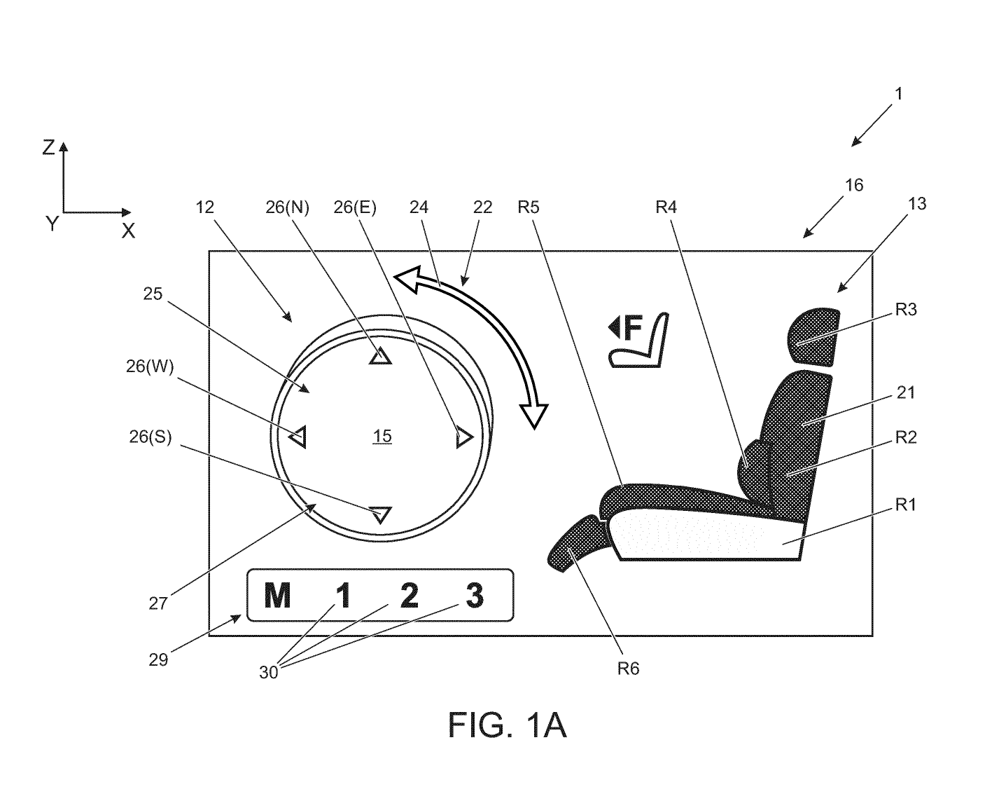

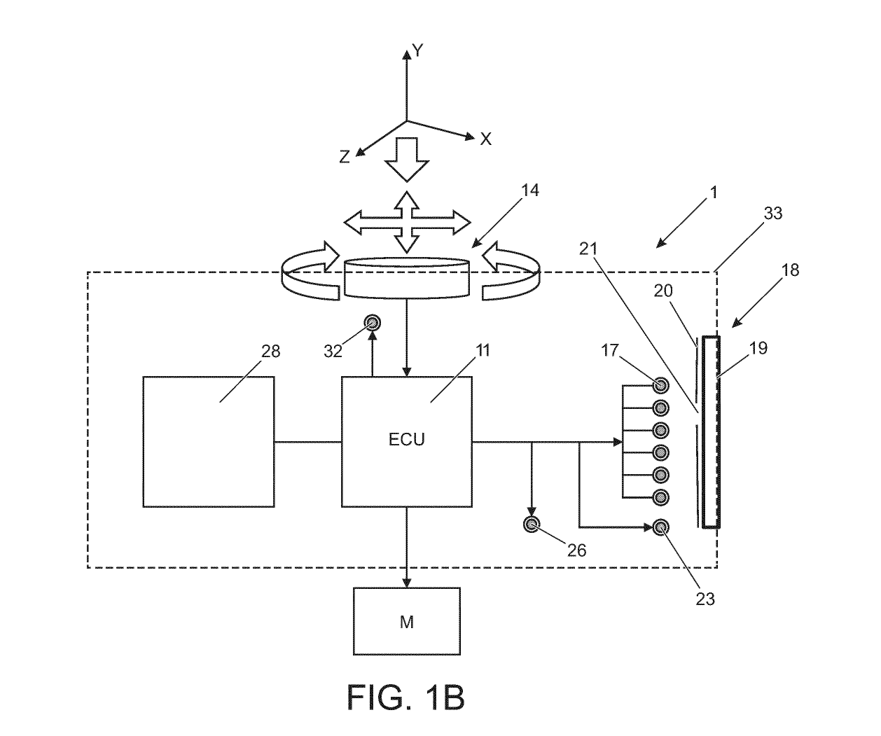

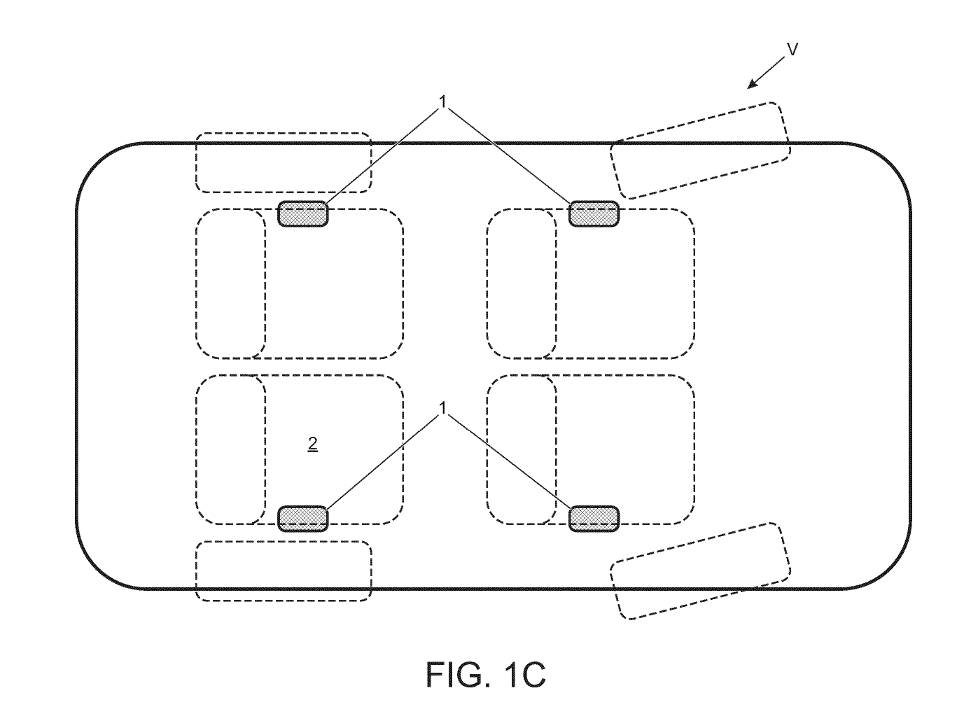

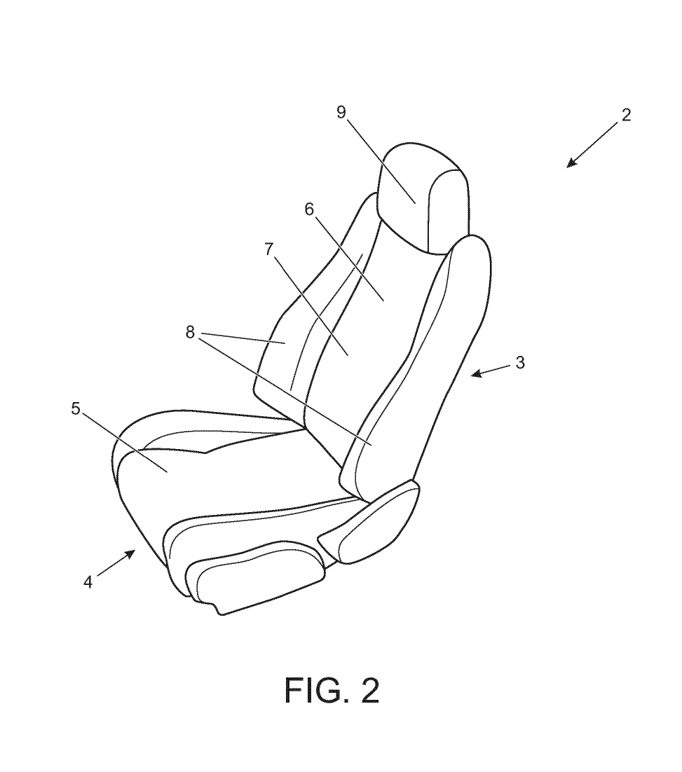

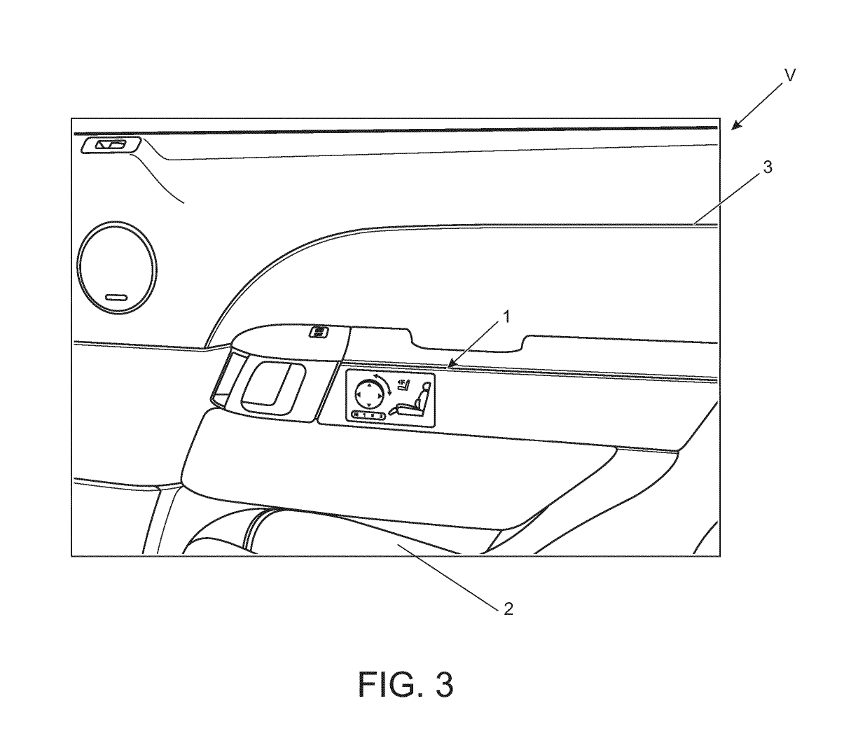

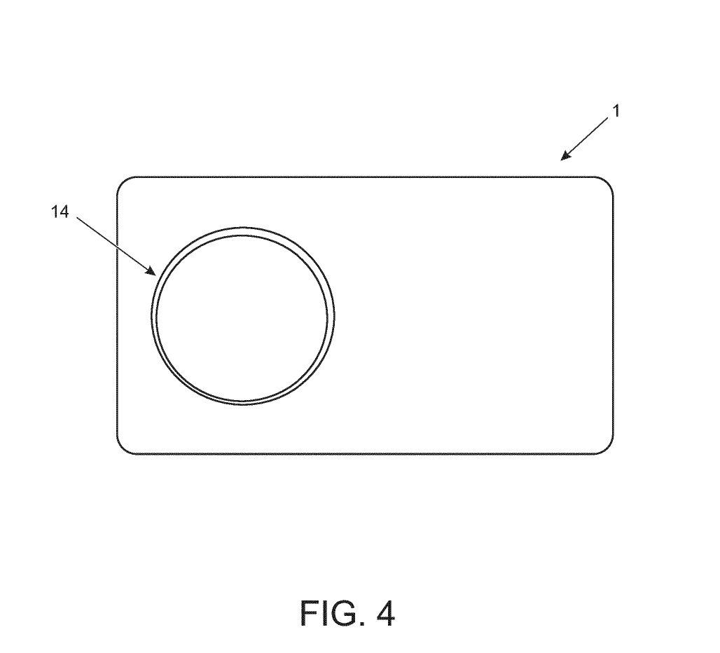

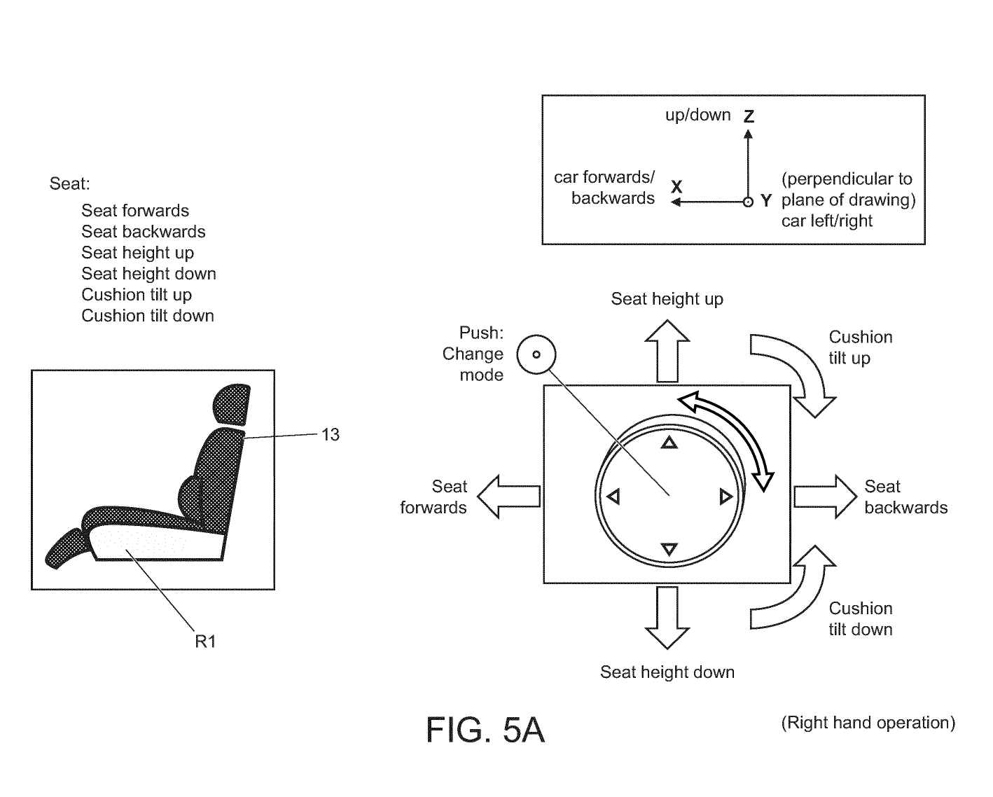

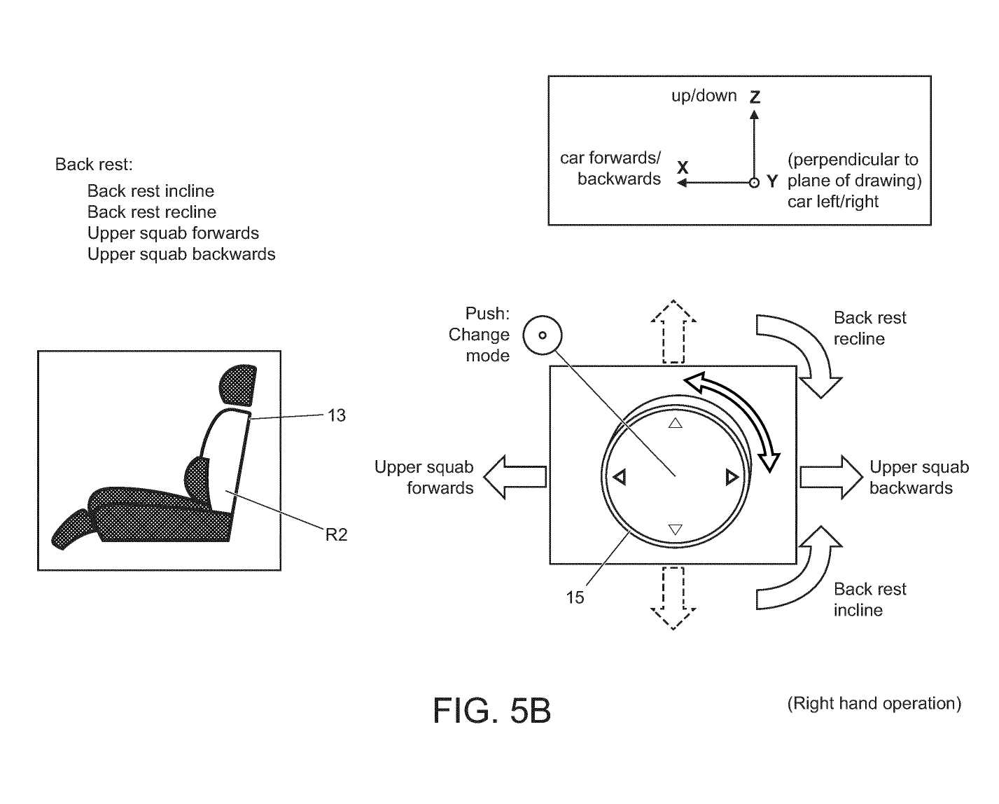

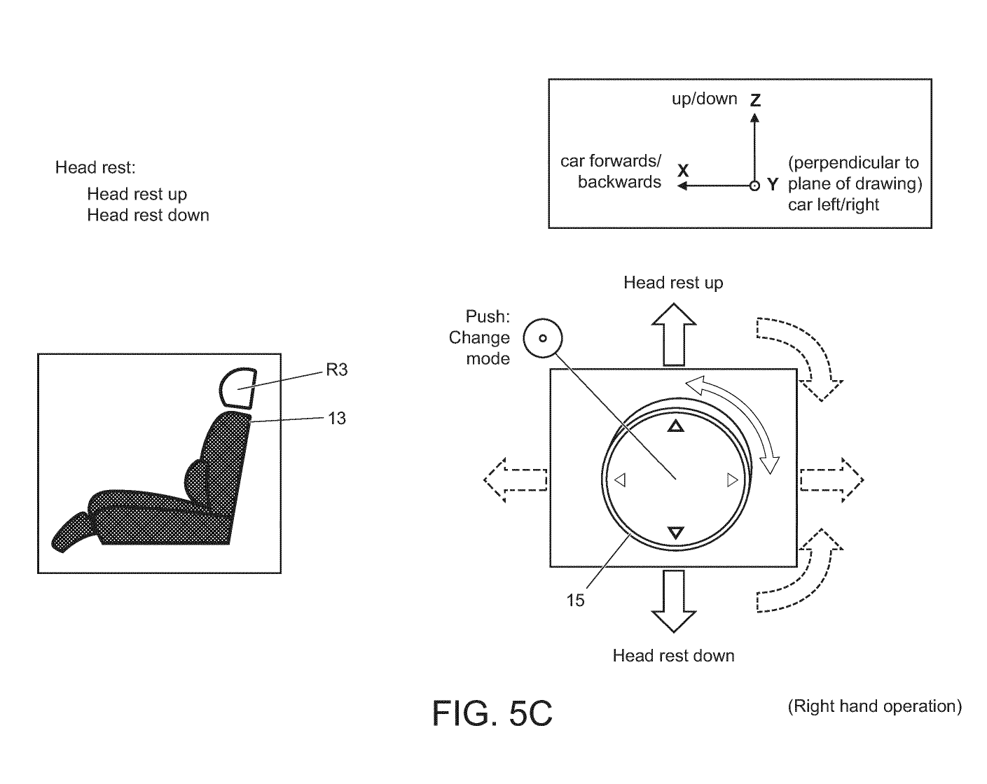

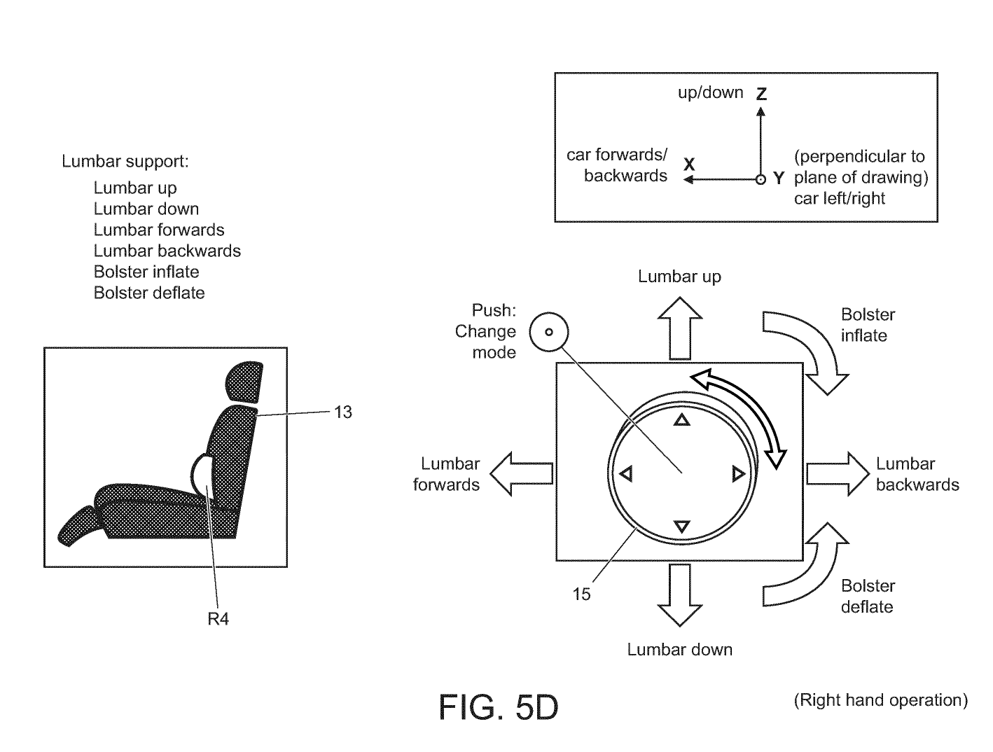

FIG. 2 shows a perspective view of a vehicle power seat to be controlled by the seat control apparatus shown in FIG. 1;

FIG. 3 shows the seat control apparatus according to an embodiment of the present invention installed in a door armrest;

FIG. 4 shows a schematic representation of the seat control apparatus in a de-activated state;

FIGS. 5A-F shows a schematic representation of the control modes selectable by the seat control apparatus shown in FIG. 1;

FIG. 6 shows a schematic representation of the seat control apparatus in a second control mode; and

FIG. 7 shows a schematic representation of the seat control apparatus in a third control mode.

### DETAILED DESCRIPTION

A seat control apparatus 1 for configuring adjustable parameters of a power seat 2 in accordance with an embodiment of the present invention is shown in FIGS. 1A and 1B.

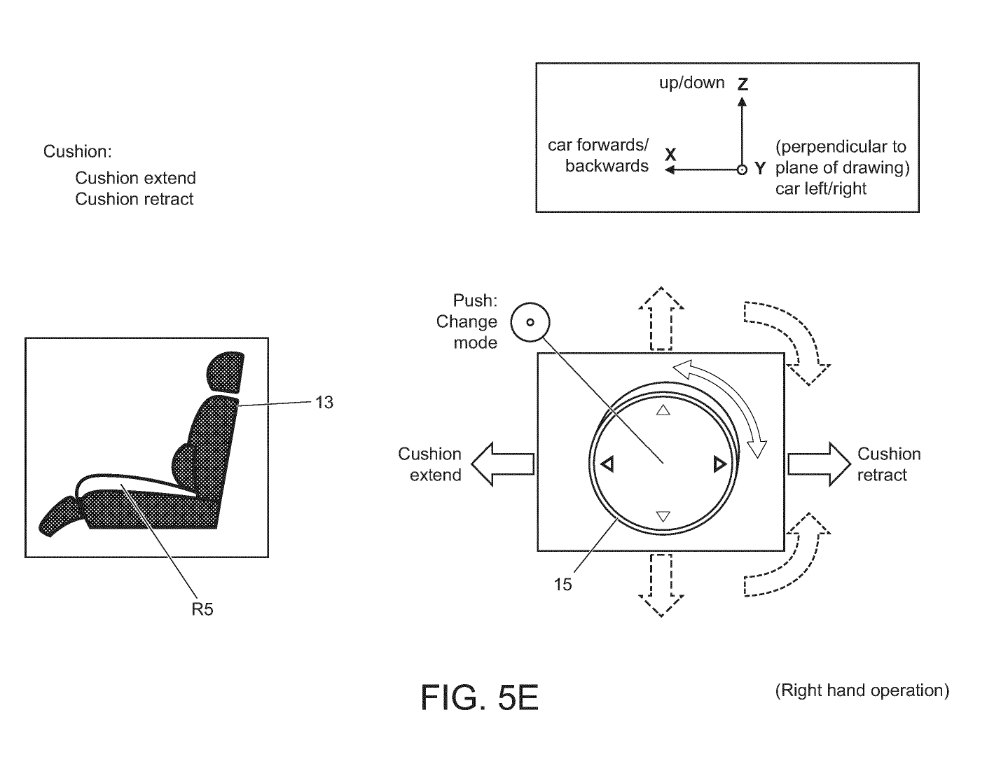

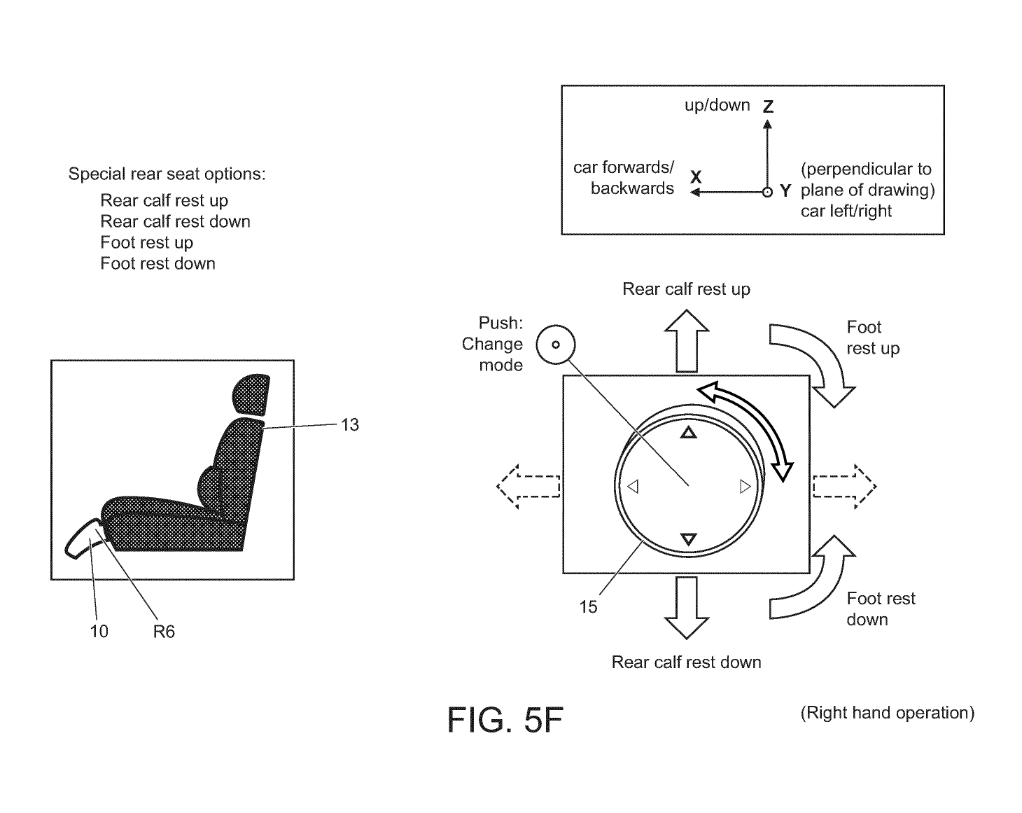

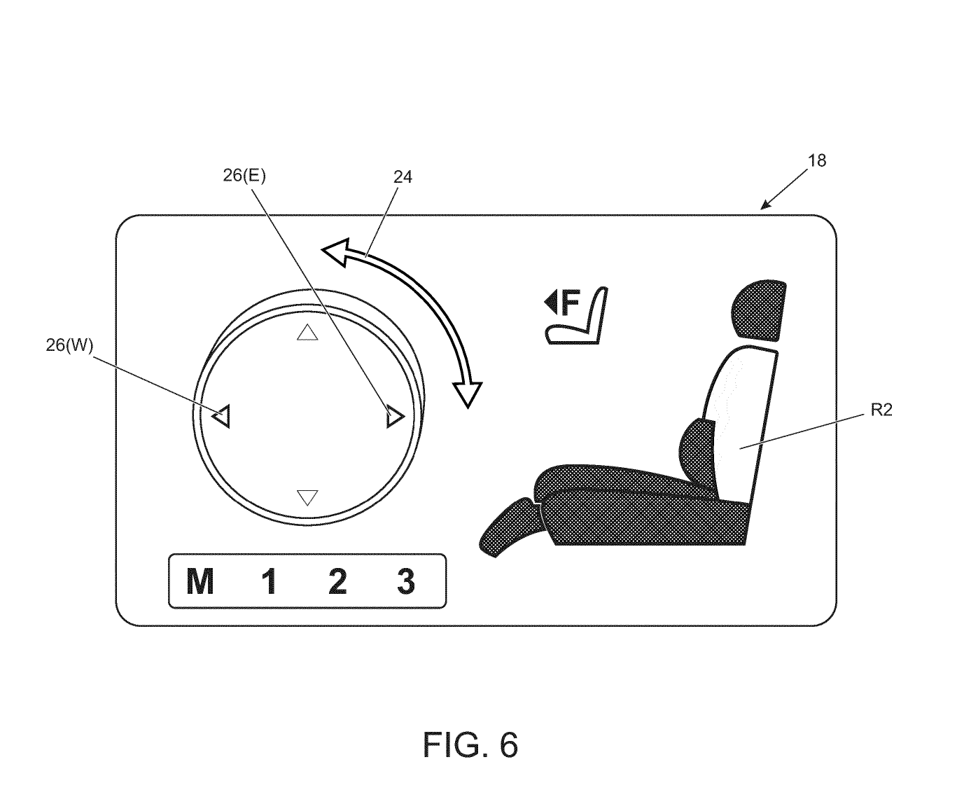

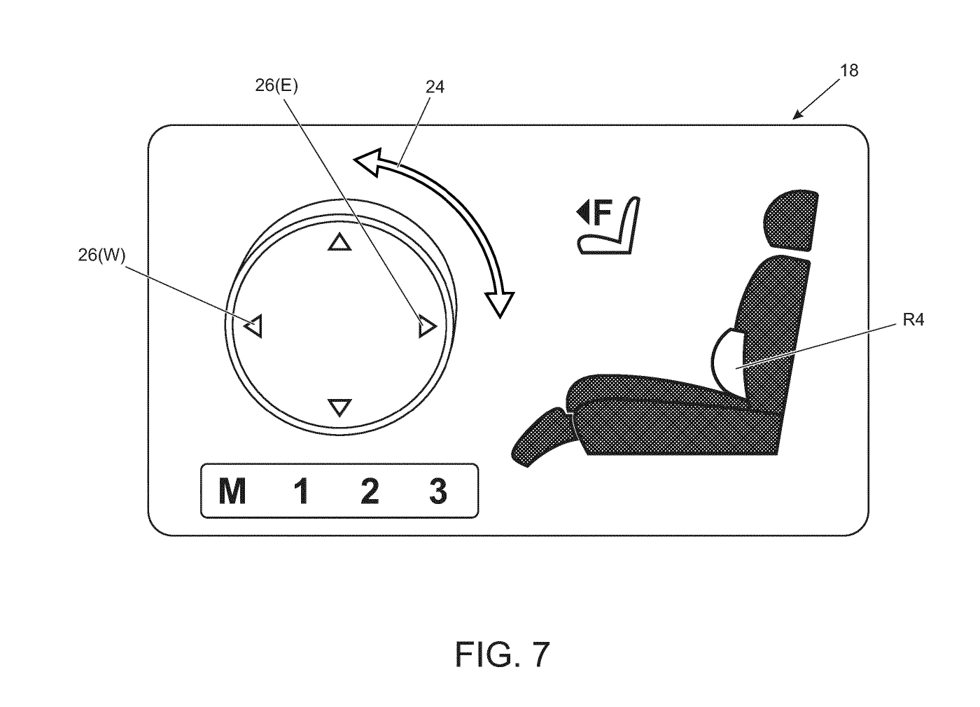

A vehicle V incorporating a plurality of the seat control apparatus 1 is shown schematically in FIG. 10. Each seat control apparatus 1 is associated with one power seat 2 in the vehicle V. The functionality of each seat control apparatus 1 can be matched to those parameters of the associated power seat 2 which are configurable. In particular, one or more control function of the seat control apparatus 1 can be enabled or disabled in dependence on the functionality of the associated power seat 2.

The seat control apparatus 1 will be described herein by way of example with reference to a single one of said power seat 2, namely the power seat 2 in a rear, right hand position of a vehicle V. As shown in FIG. 3, the seat control apparatus 1 is mounted vertically in a door armrest adjacent to the power seat 2.

The seat control apparatus 1 is configured to provide a human machine interface (HMI) for configuring the power seat 2. The seat control apparatus 1 can be configurable depending on the control functions available for the power seat 2, for example to accommodate different functionality of front and rear seats in the vehicle. As shown in FIG. 2, the power seat 2 comprises a backrest 3, a seat base 4, a seat cushion 5, an upper squab 6, a lumbar support 7, a pair of lateral bolsters 8, a headrest 9, a calf support 10 (shown schematically in FIG. 5F) and a foot support (not shown). The backrest 3 is pivotable relative to the seat base 4 to adjust a recline angle. At least one actuator (referenced generally by the reference numeral M in FIG. 1B) is associated with the power seat 2, typically disposed within the power seat 2, to provide remote adjustment of the seat settings. Each actuator can, for example, be in the form of one or more of the following: a drive motor (for example an electric motor). Alternatively, the actuator can comprise a compressor or a pump fluidly connected to a pneumatic support.

In the present embodiment the adjustable seat parameters in the power seat 2 are as follows:
(a) longitudinal translation of the seat cushion 5;
(b) adjustment of the lateral bolsters 8;
(c) longitudinal and/or vertical translation of the lumbar support 7;
(d) positioning of the upper squab 6;
(e) incline angle of the backrest 3;
(f) vertical translation of the headrest 9 to adjust height;
(g) vertical translation of the power seat 2 to adjust rise height;
(h) horizontal translation of the power seat 2;
(i) rotational movement of the seat cushion 5 to adjust tilt;
(j) raising/lowering the calf support 10; and
(k) raising/lowering the foot support.

Additional functions could include adjusting an angular position of lateral supports (not shown) mounted to the headrest 9. The seat control apparatus 1 could also be configured to adjust a temperature control element disposed in the power seat 2, for example to increase/decrease the temperature. The seat control apparatus 1 could also be configured to select and/or activate a seat massage function.

The seat control apparatus 1 defines six control modes R1-6 and one or more of the aforementioned seat parameters is associated with each said control mode R1-6. The first control mode R1 relates to adjustment of the height and/or position of the power seat 2; the second control mode R2 relates to adjustment of the upper squab 6; the third control mode R3 relates to adjustment of the headrest 9; the fourth control mode R4 relates to adjustment of the lumbar support; the fifth control mode R5 relates to adjustment of the seat cushion 5; and the sixth control mode R6 relates to adjustment of the calf support 10 and/or the foot support. As described herein, the seat control apparatus 1 is configured to allow a user to cycle through the six control modes R1-6 in a predetermined sequence.

As shown schematically in FIG. 1B, the seat control apparatus 1 comprises an electronic control unit 11, an operating member 12, a first electronic display 13 and a second electronic display 14. The electronic control unit 11 comprises one or more electronic microprocessors connected to one or more electronic storage devices. The electronic control unit 11 is configured to receive user inputs from the operating member 12; and to output control signals to the at least one actuator to adjust the settings of the power seat 2 in dependence on the user inputs. The electronic control unit 11 is also configured to control the first and second electronic displays 13, 14. Alternatively, the output control signals can be output to another module configured to control the at least one actuator associated with the power seat 2.

The operating member 12 in the present embodiment is in the form of a 7-directional control knob 15 operable to provide seven input functions. The control knob 15 is spring biased towards a neutral position. As illustrated in FIG. 1B, the control knob 15 can be pivoted up and down about a longitudinal axis X; rotated in clockwise and anticlockwise directions about a transverse axis Y (extending out of the plane of the page in FIG. 1); pivoted forwards and backwards about a vertical axis Z; and depressed along the transverse axis Y. The control modes R1-6 can be selected using the control knob 15. In particular, the control modes R1-6 can be cycled by depressing the control knob 15. If the control knob 15 is depressed and released, the electronic control unit 11 automatically selects the next control mode R1-6 in the predetermined sequence. If the control knob 15 is depressed and held, the electronic control unit 11 is configured automatically to select a predefined one of said control modes R1-6 irrespective of the predetermined sequence. In a variant, the user could cycle through the control modes R1-6 by rotating the control knob 15. Once one of said control modes R1-6 has been selected, the control knob 15 can be used to adjust the seat parameters associated with the selected control mode R1-6. The control knob 15 can optionally also be movable between an operative (extended) position and a non-operative (retracted) position. The seat control apparatus 1 can comprise an actuator (not shown) for displacing the control knob 15 along said transverse axis Y. The actuator can operate to retract the control knob 15 when the seat control apparatus 1 is not in use, for example when the vehicle ignition is switched off. Conversely, the actuator can operate to extend the control knob 15 when the seat control apparatus 1 is in use, for example when the seat control apparatus 1 is woken from a “sleep” mode or the vehicle ignition is switched on. The actuator can, for example, comprise an electric motor and an output drive.

As shown in FIGS. 1A and 1B, the first electronic display 13 comprises a first display panel 16 having first light emitting elements 17 mounted behind a fascia panel 18 (shown schematically in FIG. 1B). The fascia panel 18 comprises a tinted glass panel 19 and an opaque substrate 20. The substrate 20 is applied to a back face of the panel 19 to form an optical mask. The substrate 20 comprises a plurality of windows 21 (six in the present embodiment) arranged to form a graphical representation of the power seat 2. The windows 21 each define a segment of the graphical representation corresponding to one of the control modes R1-6 of the power seat 2. The first light emitting elements 17 are controllable independently of each other to provide a visual indication of the status of each control mode R1-6 (for example to indicate whether each operating mode R1-6 is in a selected or an un-selected state). The first light emitting elements 17 can, for example, be light emitting diodes (LEDs) or organic light emitting diodes (OLEDs). The seat control apparatus 1 is operatively mounted such that the fascia panel 18 is disposed substantially vertically to facilitate operation. The first display panel 16 also incorporates a capacitive touch sensor to enable the control modes R1-6 to be selected by touching the illuminated section of the fascia panel 18 corresponding to the appropriate section of the power seat 2. In a variant, the first display panel 16 could comprise a video display screen, for example comprising a liquid crystal display (LCD), for displaying a graphical representation of the power seat 2. The video display screen could be a touch screen, for example comprising a capacitive sensor.

In the present embodiment the first light emitting elements 17 each comprise a LED configured to emit light in dependence on a control signal received from the electronic control unit 11. The electronic control unit 11 is configured to adjust the intensity of light emitted by the first light emitting elements 17 to provide a visual indication of the status of the control modes R1-6. In use, one of the first light emitting elements 17 is controlled to emit light at a first intensity level to provide a visual indication that the indicated control mode R1-6 has been selected (or is available for selection); and the remaining light emitting elements are controlled to emit light at a second intensity level to provide a visual indication that the other control sounds R1-6 are active but have not been selected. The first intensity level is higher than the second intensity level. In a variant the first light emitting elements 17 can each comprise one or more coloured LED configured to emit coloured light in dependence on a control signal received from the electronic control unit 11. For example, the first light emitting elements 17 can comprise two LEDS adapted to emit two different colours of light in dependence on the control signal from the electronic control unit 11. Alternatively, the first light emitting elements 17 can comprise an RGB LED.

In addition to providing a graphical representation of the power seat 2, the first electronic display 13 also comprises a first function indicator 22. The first function indicator 22 comprises a second light emitting element 23 arranged selectively to illuminate an arrow 24 disposed adjacent to the control knob 15. The electronic control unit 11 is configured to illuminate the second light emitting element 23 to indicate when the control knob 15 is operable to provide a rotary control input. The arrow 24 is defined by an arcuate aperture formed in the substrate 20. The second light emitting element 23 can, for example, be an LED or an OLED.

The second electronic display 14 comprises a second display panel 25 having third light emitting elements 26 disposed within the control knob 15. The second display panel 25 provides a second function indicator 27. The second display panel 25 comprises four of said third light emitting elements 26 disposed at North (N), South (S), East (E) and West (W) positions on the control knob 15. The electronic control unit 11 is configured to illuminate the third light emitting elements 26 to indicate when the control knob 15 is operable to provide forward/backward inputs; and/or to provide up/down control inputs. The third light emitting elements 26 can, for example, be LEDs or OLEDs. In a variant, the second display panel 25 could comprise a video display screen, for example comprising a liquid crystal display (LCD).

The seat control apparatus 1 can optionally be coupled to a memory device 28 for storing seat position profiles containing seat configuration preferences. The seat control apparatus 1 comprises a selection module 29 disposed in the first display panel 16. The selector module 29 comprises three switches 30 for selecting respective first, second and third seat position profiles (represented by the numerals “1”, “2” and “3” in FIG. 1A). The switches 30 are backlit in the present embodiment to facilitate selection.

The seat control apparatus 1 is de-activated when the vehicle ignition is switched off. When in a de-activated state, the light emitting elements 17, 23, 26, 32 are not illuminated such that in the first display panel 16 and the second display panel 25 are at least partially hidden or obscured, as illustrated in FIG. 4. The first display panel 16 thereby provides a “secret-till-lit” function, which can be controlled in dependence on a selected mode of the seat control apparatus 1. Moreover, the actuator is operated to retract the control knob 15 to the non-operative position when the seat control apparatus 1 is de-activated. The top of the control knob 15 is disposed substantially flush with the surface of the fascia panel 18. The seat control apparatus 1 could also be de-activated (or enter a “sleep” mode) when it is not in use, for example if it is not used for a predetermined period of time. The seat control apparatus 1 could be re-activated (or woken from the “sleep” mode) by depressing the control knob 15, touching the fascia panel 18 or in dependence on a signal communicated through a vehicle network. Alternatively, the seat control apparatus 1 can be re-activated by a signal transmitted over the vehicle communication network.

The operation of the seat control apparatus 1 to configure the power seat 2 will now be described with particular reference to FIGS. 5A-F. After the vehicle ignition is turned ON, the control knob 15 is raised to its operative position and the first display panel 16 and the second display panel 25 are activated. In this initial state, the first operating mode R1 is activated by default. The selection of said operating modes R1-6 can be performed either by touching the respective symbol on the first display panel 16 or by depressing the control knob 15 to cycle through the control modes sequentially. The control modes are cycled sequentially from the first control mode R1 through to the sixth control mode R6 and the cycle repeated. The seat control apparatus 1 can also provide the option of resetting back to a default one of said operating modes R1-6, such as the first operating mode R1, by depressing and holding the control knob 15. By way of example, if the fourth control mode R4 is selected and the control knob 15 is depressed and held down, the first operating mode R1 will automatically be selected.

The first control mode R1 relates to the control functions associated with the seat base 4 and the seat cushion 5, as illustrated in FIG. 5A. The configurable seat parameters associated with the first control mode R1 include: longitudinal translation (forwards/backwards) of the seat base 4; vertical translation (up/down) of the seat base 4 (i.e. rise height of the seat base 4); and tilting of the seat cushion 5. The control knob 15 is pivoted forwards and backwards to effect corresponding longitudinal movements of the power seat 2. The control knob 15 is pivoted upwards and downwards to effect corresponding vertical translation of the seat base 4. The control knob 15 is rotated in a first direction (anticlockwise in the illustrated arrangement) to tilt the seat cushion 5 upwards (i.e. to raise the front of the seat cushion 5); and rotated in a second direction (clockwise in the illustrated arrangement) to tilt the seat cushion 5 downwards (i.e. to lower the front of the seat cushion 5). When the first control mode R1 is selected, the second light emitting element 23 and the third light emitting elements 26 disposed at said North (N), South (S), East (E) and West (W) positions on the control knob 15 are illuminated to provide a visual indication of the available control functions.

The second control mode R2 relates to the back rest 3 and the upper squab 6, as illustrated in FIG. 5B. The configurable seat parameters associated with the second control mode R2 include: longitudinal (forward/rearward) movement of the upper squab 6; and rotational movement of the backrest 3 relative to the seat base 4 to adjust a recline angle. The control knob 15 is pivoted forwards and backwards to effect corresponding longitudinal movements of the upper squab 6. The control knob 15 is rotated in a first direction (anticlockwise in the illustrated arrangement) to incline the backrest 3 (to reduce the recline angle); and rotated in a second direction (clockwise in the illustrated arrangement) to recline the backrest 3 (to increase the recline angle). When the second control mode R2 is selected, the second light emitting element 23 and the third light emitting elements 26 disposed at said East (E) and West (W) positions on the control knob 15 are illuminated to provide a visual indication of the available control functions. The illumination pattern representing the available control inputs for the second control mode R2 is shown in FIG. 6.

The third control mode R3 relates to the control functions associated with the headrest 9, as illustrated in FIG. 5C. The configurable seat parameters associated with the third control mode R3 include: vertical translation (up/down) of the headrest 9. The control knob 15 is pivoted upwards and downwards to effect corresponding vertical movements of the headrest 9. When the third control mode R3 is selected, the third light emitting elements 26 disposed at said North (N), and South (S) positions on the control knob 15 are illuminated to provide a visual indication of the available control functions.

The fourth control mode R4 relates to the control functions associated with the lumbar support 7 and the lateral bolsters 8, as illustrated in FIG. 5D. The configurable seat parameters associated with the fourth control mode R4 include: longitudinal translation (forwards/backwards) of the lumbar support 7; vertical translation (upwards/downwards) of the lumbar support 7; and adjustment of the lateral bolsters 8. The control knob 15 is pivoted forwards and backwards to effect corresponding longitudinal movements of the lumbar support 7. The control knob 15 is pivoted upwards and downwards to effect corresponding vertical movements of the lumbar support 7. The control knob 15 is rotated in a first direction (clockwise in the illustrated arrangement) to inflate the lateral bolsters 8; and rotated in a second direction (anticlockwise in the illustrated arrangement) to deflate the lateral bolsters 8. When the fourth control mode R4 is selected, the second light emitting element 23 and the third light emitting elements 26 disposed at said North (N), South (S), East (E) and West (W) positions on the control knob 15 are illuminated to provide a visual indication of the available control functions. The illumination pattern representing the available control inputs for the fourth control mode R4 is shown in FIG. 7.

The fifth control mode R5 relates to the control functions associated with the seat cushion 5, as illustrated in FIG. 5E. The configurable seat parameters associated with the fifth control mode R5 include: longitudinal translation (forwards/backwards) of the seat cushion 5. The control knob 15 is pivoted forwards and backwards to effect corresponding longitudinal movements of the seat cushion 5. When the fifth control mode R5 is selected, the third light emitting elements 26 disposed at said East (E) and West (W) positions on the control knob 15 are illuminated to provide a visual indication of the available control functions.

The sixth control mode R6 relates to the control functions associated with the calf support and the foot support, as illustrated in FIG. 5F. The sixth control mode R6 is typically available when the seat control apparatus 1 is used in conjunction with a rear seat of the vehicle. The configurable seat parameters associated with the sixth control mode R6 include: vertical translation (up/down) of the calf support; and vertical translation (up/down) of the foot support. The control knob 15 is pivoted upwards and downwards to effect corresponding vertical movements of the calf support. The control knob 15 is rotated in a first direction (anticlockwise in the illustrated arrangement) to lower the foot support; and rotated in a second direction (clockwise in the illustrated arrangement) to raise the foot support. When the sixth control mode R6 is selected, the second light emitting element 23 and the third light emitting elements 26 disposed at said North (N) and South (S) positions on the control knob 15 are illuminated to provide a visual indication of the available control functions.

At least in certain embodiments, the seat control apparatus 1 can provide an intuitive user interface to facilitate configuration of the power seat 2. It will be appreciated that the operating member 12 and the first electronic display 13 are co-located within the seat control apparatus 1. In the present embodiment, the operating member 12 and the first electronic display 13 are juxtaposed to each other. To facilitate installation, the seat control apparatus 1 can be incorporated into a single casing or housing (represented schematically by the reference numeral 33 in FIG. 1B).

The seat control apparatus 1 in the present embodiment has been described as enabling selection of six control modes R1-6. At least in certain embodiments, the seat control apparatus 1 can be configured selectively to activate/de-activate one or more of said control modes R1-6. This enables the seat control apparatus 1 to be selectively reconfigured for use in different applications. The seat control apparatus 1 could be modified to provide selection of less than or more than six control modes R1-6. This can be performed electronically, for example by transmitting a control signal to the seat control apparatus 1. It will be appreciated that the seat control apparatus 1 can be configurable in this manner irrespective of the number of control modes R1-6.

It will be appreciated that various changes and modifications can be made to the seat control apparatus 1 described herein without departing from the scope of the present application. For example, in addition to indicating the current operating mode R1-6 on the first display panel 16, the electronic control unit 11 could output a status signal to a vehicle network. The status signal could prompt the display of a graphical image and/or a textual message on another display device, for example disposed in a central console.

1. A seat control apparatus for configuring a vehicle power seat, the seat control apparatus comprising:
an operating member configured to cycle through a plurality of control modes, each of the plurality of control modes associated with at least one configurable seat parameter;
wherein the operating member is operable to select one of the control modes and to adjust the at least one configurable seat parameter associated with the selected control mode.

2. The seat control apparatus as claimed in claim 1, wherein the seat control apparatus is configured to activate and/or deactivate one or more of the control modes.

3. The seat control apparatus as claimed in claim 1, wherein the control modes are accessible in a predetermined sequence.

4. The seat control apparatus as claimed in claim 3, wherein the operating member is operable to select a next control mode in a predetermined sequence.

5. The seat control apparatus as claimed in claim 4, wherein the operating member is depressed to select the next control mode.

6. The seat control apparatus as claimed in claim 1, wherein the operating member is rotatable to adjust the at least one configurable seat parameter associated with the selected control mode.

7. The seat control apparatus as claimed in claim 1, wherein the operating member is pivotable and/or translatable to adjust the at least one configurable seat parameter associated with the selected control mode.

8. The seat control apparatus as claimed in claim 1, further comprising a first electronic display for providing a visual indication of which one of the control modes is currently selected.

9. The seat control apparatus as claimed in claim 8, wherein the first electronic display is located adjacent to or proximal to the operating member.

10. The seat control apparatus as claimed in claim 1, wherein the seat control apparatus comprises a second electronic display for providing a visual indication of one or more control functions available for adjusting the at least one configurable seat parameter associated with the selected control mode.

11. The seat control apparatus as claimed in claim 1, wherein at least one first control function is available in a first control mode, and at least one second control function is available in a second control mode, wherein the at least one first control function is different from the at least one second control function.

12. The seat control apparatus as claimed in claim 10, wherein the second electronic display comprises a second electronic display located on the operating member.

13. The seat control apparatus as claimed in claim 1, wherein the at least one configurable seat parameter comprises one or more of the following: seat cushion extension, lumbar support, lumbar position, bolster position, headrest articulation, upper squab articulation, headrest height, seat height rise, cushion incline, calf support position, foot support position, temperature control, and ventilation control.

14. The seat control apparatus as claimed in claim 1, wherein the seat control apparatus is re-configured in dependence on the at least one configurable seat parameter that is available.

15. The seat control apparatus as claimed in claim 1, wherein the seat control apparatus is configurable and/or reconfigurable electronically via a configuration signal.

16. The seat control apparatus as claimed in claim 1, wherein the seat control apparatus is in the form of an integrated switch pack for installation in a center console, an armrest, a vehicle door or a seat base.

17. The seat control apparatus as claimed in claim 1, wherein the control member is movable between a non-operative position and an operative position.

18. A vehicle seat coupled to a seat control apparatus as claimed in claim 1.

19. A vehicle incorporating one or more seat control apparatus as claimed in claim 1.

20. (canceled)
